(19) United States
(12) Patent Application Publication
(10) Pub. No.: US 2019/0126544 A1
(43) Pub. Date: May 2, 2019

(54) ACCESSORY FOR THREE-DIMENSIONAL PRINTING

(71) Applicant: HEWLETT-PACKARD DEVELOPMENT COMPANY, L.P., Houston, TX (US)

(72) Inventors: Pau MARTIN VIDAL, Barcelona (ES); Lluis HIERRO DOMENECH, Barcelona (ES); Gerard MOSQUERA, Barcelona (ES); Marius VALLES, Barcelona (ES); Joan MACH BENEYTO, Barcelona (ES)

(73) Assignee: HEWLETT-PACKARD DEVELOPMENT COMPANY, L.P., Houston, TX (US)

(21) Appl. No.: 16/089,866

(22) PCT Filed: Nov. 29, 2016
(86) PCT No.: PCT/US2016/063960

§ 371 Date: Sep. 28, 2018

(51) Int. Cl. B29C 64/245; B33Y 30/00; B33Y 50/02; B29C 64/393

(52) U.S. Cl. CPC B29C 64/245; B29C 64/393; B33Y 50/02; B33Y 30/00

(57) ABSTRACT

According to one example, there is provided an accessory for a three-dimensional (3D) printer. The accessory comprises an upper structure to connect to a 3D printer build unit, the build unit defining a build chamber and having a movable support platform, the upper structure defining a build chamber smaller than the build chamber of the build unit, the upper structure being connectable to the build unit such that the accessory build chamber becomes the usable build chamber of the build unit, and an accessory support platform movable within the accessory build chamber, the accessory support platform having a base portion extending below the accessory build chamber to connect to the build unit support platform, such that movement of the build unit support platform causes corresponding movement of the accessory support platform.

### BACKGROUND

Additive manufacture systems, commonly known as three-dimensional (3D) printers, enable objects to be generated on a layer-by-layer basis. Powder-based 3D printing systems, for example, form successive layers of a build material in a build chamber and selectively solidify portions of the build material to form layers of the object or objects being generated.

### BRIEF DESCRIPTION

Examples will now be described, by way of non-limiting example only, with reference to the accompanying drawings, in which:

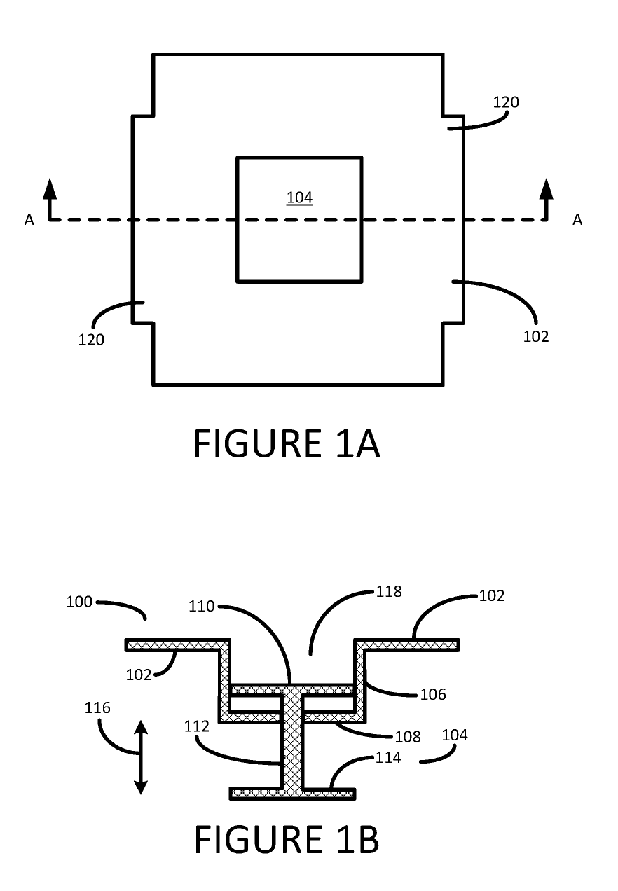

FIG. 1A is a plan view of an accessory for a 3D printer according to one example;

FIG. 1B is a corresponding cross-section view of the accessory of FIG. 1 according to one example;

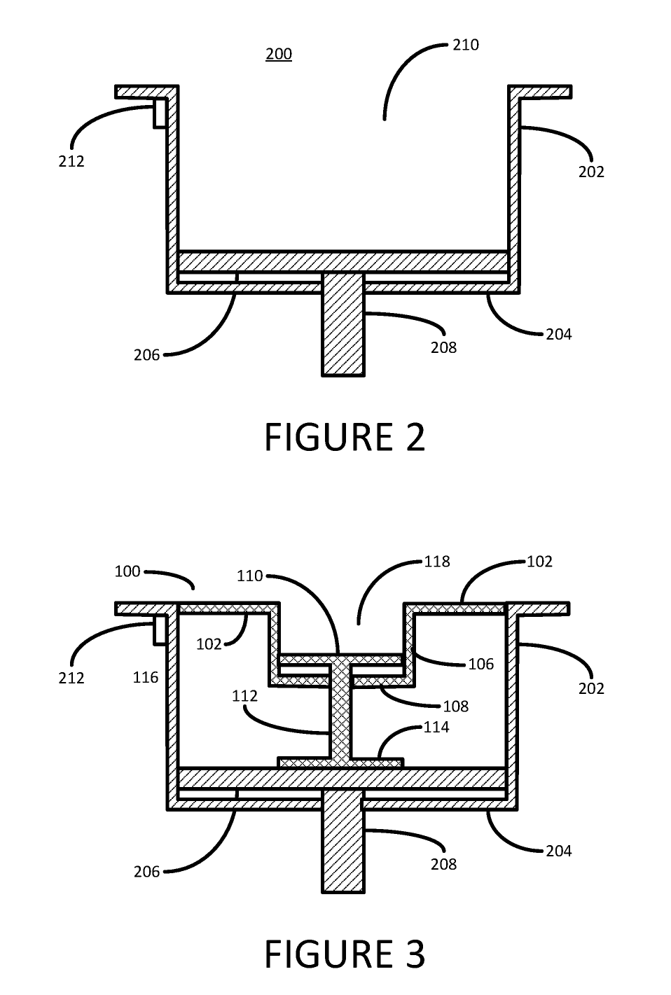

FIG. 2 is a cross-section view of a build unit for a 3D printer according to one example;

FIG. 3 is a cross-section view of an accessory for a 3D printer installed in a 3D printer build unit according to one example;

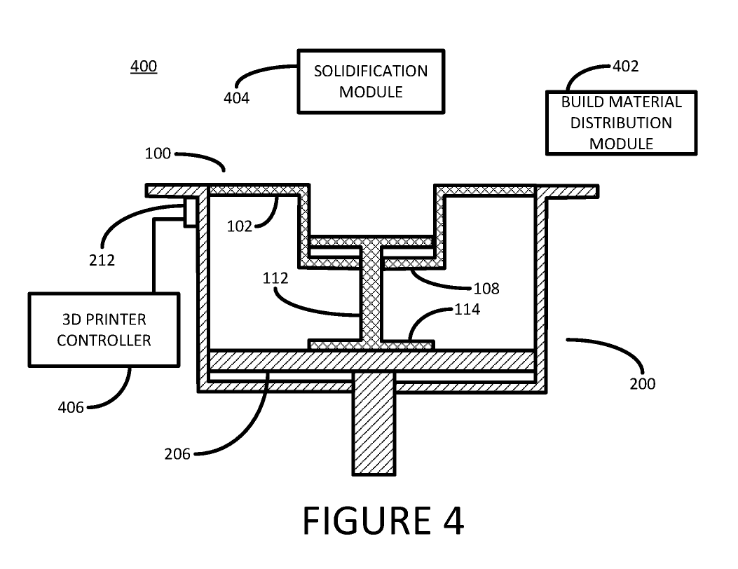

FIG. 4 is an illustration of a 3D printer according to one example;

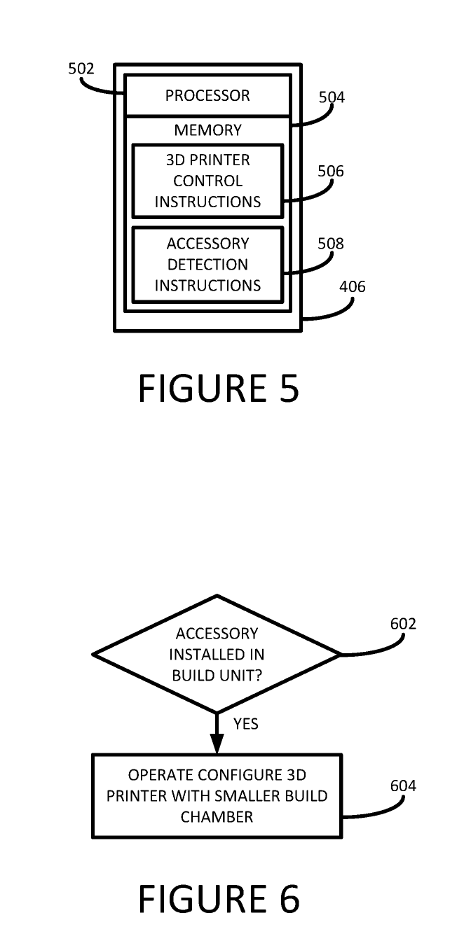

FIG. 5 is a block diagram of a 3D printer controller according to one example;

FIG. 6 is a flow diagram outlining a method of operating a 3D printer according to one example;

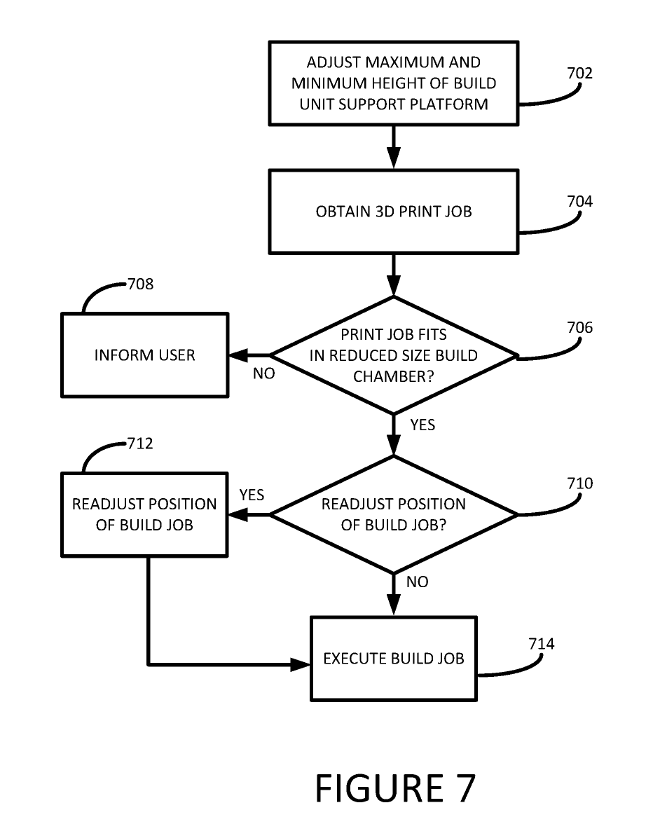

FIG. 7 is a flow diagram outlining a method of operating a 3D printer according to one example;

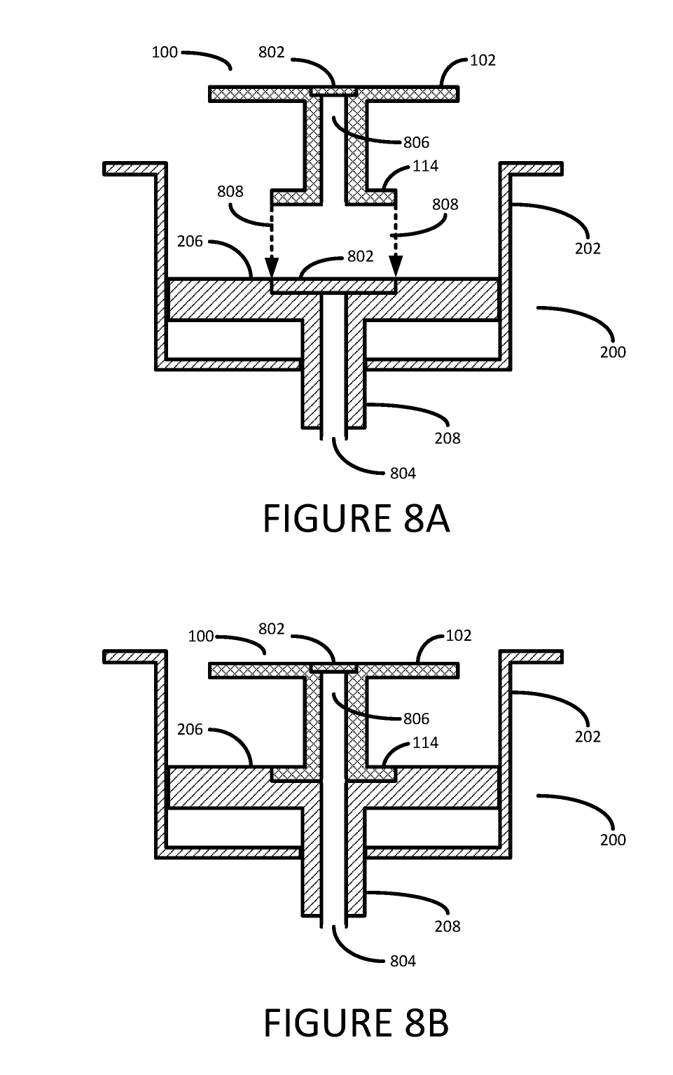

FIG. 8A is a cross-section view of a build unit and a 3D printer build unit according to one example; and

FIG. 8B is a cross-section view of a build unit and a 3D printer build unit according to one example.

### DETAILED DESCRIPTION

Powder-based 3D printing systems generate objects by forming successive layers of build material on a movable support platform. Portions of each layer may be selectively solidified, using any suitable technique, and the support platform may be lowered into a build chamber (also known as a build volume) to enable the next layer of build material to be formed. Suitable selective solidification systems include, for example, laser sintering systems, chemical binder systems, and fusing agent and fusing energy systems.

In such powder-based 3D printing system, the time it takes to generate an object or objects is dependent largely on the type of selective solidification technique used and the size of the build chamber provided by a 3D printer build unit. For example, if each layer of been material formed has a height of 100 microns, this means that an object 10 cm high may be formed of at least 1000 layers of build material (depending on the degree of contraction exhibited by solidified portions of the build material). If each layer takes on average 10 seconds to process, this would lead to an object generation time of almost 3 hours. Depending on the type of selective solidification systems used this time could further increase. For example, fusing agent and fusing energy systems (such as HP Multi Jet Fusion systems) may have a generally constant layer processing time that is largely independent of the number and complexity of objects being generated. Laser sintering systems, on the other hand, have a layer processing time that is much more dependent on the number and complexity of objects being generated since the time taken to scan a laser beam over of each portion of the build material to be solidified for any given layer of build material may vary dramatically between different layers.

3D printing systems with larger build chambers are generally more time efficient when generating large objects, or large numbers of objects. Furthermore, for a given build chamber, powder-based 3D printing system may use roughly the same amount of build material irrespective of the number and type of objects being generated.

Different 3D printer users may have different needs at different times. For example, during an object prototyping phase users may place a higher priority on speed of generating single or low numbers of objects. During a production phase users may place a higher priority on speed of generating large numbers of objects.

Referring now to FIG. 1, there is shown an accessory for a 3D printing system, such as a powder-based 3D printer according to one example. FIG. 1A shows a plan view of the accessory 100, and FIG. 1B shows a corresponding section view of the accessory 100 in the plane A-A.

The accessory 100 is designed to be insertable into, and removable from, a build unit of a 3D printing system to enable the effective size of a 3D printer build chamber to be reduced. In this way, the accessory enables a 3D printer designed for efficient volume production to additionally be efficiently used for object prototyping. In some examples the build unit may be an integrated build unit of a 3D printer. In other examples, the build unit may be a removable build unit that may be used with a 3D printer.

The accessory 100 comprises an upper structure 102 and a movable lower structure shown generally as 104. The upper structure 102 comprises side walls 106 and an apertured base portion 108 into which is positioned a movable support platform 110. The support platform 110 has support member 112 and a base portion 114. The support platform 110 may be raised and lowered within the walls 106, as indicated by arrow 116, to form an open and variable size build chamber 118.

As shown in FIG. 1A, the shape of the upper structure may be designed to provide protrusions 120 to enable connection to a build unit of a 3D printing system.

The accessory 100 may be formed of any suitable rigid material, including metal, and high-temperature resistant plastic.

FIG. 2 shows a cross-sectional view of a portion of a 3D printer build unit 200 into which the accessory 100 is designed to be installed. The build unit 200 comprises side walls 202 and an apertured base 204 into which is positioned a movable support platform 206. The support platform 206 is coupled to a support member 208 which may be directly or indirectly coupled to a drive mechanism (not shown) to enable the support platform 206 to be accurately raised and lowered, for example as each layer of build material is formed and processed during a 3D printing operation.

In the example shown the build unit 200 further comprises a sensor 212, such as a switch, to determine when the accessory 100 is inserted thereinto. The switch may indicate the presence of the accessory to a 3D printer to enable the 3D printer to modify its operation when the accessory is fitted into the build unit 200. In another example, no switch may be present in the build unit 200 and a user may have to manually indicate to a 3D printer the presence of the accessory 100. In one example, accessories having build chambers having different characteristics may be insertable into a build unit, and the build unit may comprise one or multiple switches or other detection systems to allow a 3D printer to determine what a kind of accessory inserted into a build unit. For example, different accessories may have build chambers having different dimensions and/or different shapes, or other characteristics.

Referring now to FIG. 3, there is a shown a cross-section view of the build unit 200 when the accessory 100 has been installed therein. To more clearly differentiate the build unit from the accessory linear hatching has been used to indicate the build unit 200, and cross-hatching has been used to indicate the accessory 100.

As can be seen in FIG. 3, when the accessory 100 is inserted into the build unit 200 the top of the accessory fits in a secure manner and flush with the top surface of the build unit 200. When installed, the upper portion of the accessory 100 remains static. In this way, the accessory 100 may be used with existing processes performed by a 3D printing system in which the build unit 200 is used. Such processes may include, for example, formation of build material layers, printing of one or more liquid agents, application of fusing energy, scanning of a laser, and so on. As shown in FIG. 1 the protrusions 120 of the accessory 100 may correspond to accessory receiving recesses (not shown) that may be provided on the build unit and into which the protrusions fit. In one example, the build unit recesses may be covered, for example by removable covers, when the accessory is not installed to provide the build unit 200 with a smooth and flush upper surface. The connection between the top of the accessory 100 and the build unit 200 may be comprise any suitable connection elements or combination of connection elements, such magnetic connections, mechanical connections such as push-fit connections and screw connections, etc.

The base 114 of the accessory is connectable to the build unit support platform 206. In one example the connection may be made by way of coupling elements, such as magnetic coupling elements, for example, through magnets incorporated into the base 114 of the accessory to magnetically connect to the support platform 206 when made of a suitable material. In other examples, other kinds of coupling elements may be used, for example mechanical connectors, screw connectors, and the like. Once the base 114 is securely connected to the build unit support platform 206, the height of the accessory support platform 110 may be controlled, for example moved up and down, by controlling the drive mechanism coupled to the build unit support platform 206. In this manner, the accessory build chamber replaces the build unit build chamber to become the new usable build chamber of the build unit.

FIG. 4 shows a simplified schematic diagram of a 3D printer 400 according to one example. The 3D printer 400 comprises a build unit 200 into which an accessory 100, for example as previously described, is installed.

The 3D printer 400 additionally comprises a build material distribution module 402 to form layers of build material on a support platform. The build material distribution module 402 may comprise, for example, a wiper or roller to spread build material over the surface of a support platform to form thereon a layer of build material. When the accessory 100 is installed the build material distribution module 402 will form layers of build material on the support platform of the accessory, and when the accessory 100 is not present will form layers of build material on the support platform 206 of the build unit 200.

The 3D printer 400 further comprises a solidification module 404 to selectively solidify portions of each formed layer of build material. When the accessory 100 is installed the solidification module 404 will selectively solidify layers of build material formed on the support platform of the accessory, and when the accessory 100 is not present will selectively solidify layers of build material on the support platform of the build unit 200. The selective solidification may be performed, for example, based on data derived from a 3D object model of an object or objects to be generated. The data may, for example, be included in a digital print job file. The solidification module 404 may use any suitable selective solidification techniques, such as those previously described. For example the solidification module 404 may comprise one or more printheads to print a fusing agent onto a formed layer of build material, and may additionally comprise a fusing energy source to cause portions of a layer of build material onto which fusing agent is printed to fuse and solidify.

The 3D printer 400 further comprises a 3D printer controller 406 to control the general operation of the 3D printer 400. For example, the 3D printer controller 406 may control the build unit 200, the build material distribution module 402, and the solidification module 404 in accordance with 3D printer control instructions. A more detailed illustration of the 3D printer controller 406, according to one example, is shown in FIG. 5.

The 3D printer controller 406 comprises a processor 502, such as a microprocessor. The processor 502 is coupled to a memory 504. The memory 504 stores 3D printer controller instructions 506 that, when executed by the processor 502, control the 3D printer to operate, for example as described herein. The memory 504 additionally stores accessory detection instructions 508 that, when executed by the processor, modify the behavior of elements of the 3D printer 400 as described further below.

Example operation of the 3D printer 400 will now be described with additional reference to the example flow diagrams of FIGS. 6 and 7.

At 602, the controller 406 determines whether the accessory 100 has been installed into the build unit 200. As previously described, this may, for example, be determined from the sensor 212, or by a user manually indicating through a user interface that the accessory 100 has been installed.

At 604, the controller 406 operates the 3D printer with the smaller build chamber provided by the accessory 100. An example method of operating a 3D printer is shown in FIG. 7.

At 702, the controller 406 adjusts the maximum and minimum height limits s of the build unit support platform 206 to take into account the presence of the accessory 100. In one example the height limits are logical height limits that prevent the support platform 206 from being moving there beyond. For example, the logical height limits may be used by a support platform drive mechanism (not shown).

For example, since the accessory 100 takes up space in the build unit build chamber 210, the maximum height of the build unit support platform 206 has to be limited to prevent the build unit support platform 206 from contacting or interfering with the base of the accessory 100. Similarly, the minimum height of the build unit support platform 206 has to be limited to prevent the build unit support platform from contacting or interfering with the accessory support platform below the level of the upper surface of the base 108 of the accessory 100.

At 704, the controller 406 obtains a 3D print job. The 3D print job comprises data that is to be used by the controller 406 to control operation of the 3D printer to generate the 3D object(s) described therein. For example, the print job data may be derived from a 3D object model.

At 706, the controller 406 determines whether the 3D print job will fit in the reduced size build chamber of the accessory 100. If the obtained print job will not fit in the reduced size build chamber at block 708 the controller 406 takes an appropriate action, such as for example informing the user, or adjusting the build job. In one example, a determination of whether the 3D print job will fit in the reduced size build chamber may comprise determining geometric boundaries of any objects defined in the print job, and determining whether the generation of the objects is possible within the reduced size build chamber.

At block 710, the controller 406 determines whether the build job, or any objects defined therein, are to be repositioned such that they will be appropriately generated within the build chamber of the accessory. If the build job is to be repositioned this is performed by the controller 406 at block 712. Repositioning may comprise, for example, setting the x, y, and z axis start points for the obtained print job or objects defined therein, such that the 3D printer will generate the contents of the print job within the build chamber of the accessory 100.

At block 714, the controller 406 controls elements of the 3D printer 400 to generate the contents of the print job within the build chamber of the accessory 100. For example, the controller 406 may control the build material distribution module 402 to form a new layer of build material on the support platform for the accessory, and may control the solidification module 404 to selective solidify portions of each formed layer of build material, in accordance with the print job. The controller 406 may control operation of the 3D printer 400 in accordance with the print job until the contents of the print job have been generated.

A further example of an accessory 102 is illustrated in FIG. 8A and 8B. The accessory 102 is designed for use with a build unit 200 similar to the build unit shown in FIG. 3, wherein the support platform 206 has a removable refilling cap 802. When removed, the refilling cap 802 provides access to a refilling channel 804 through which build material may be added to a build unit build material store (not shown) located, for example, below the support platform 206. As shown in FIG. 8A, the accessory 100, for which the upper structure 102 is not shown for clarity, additionally comprises an accessory refilling cap 802 which, when removed, provides access to an accessory filling channel 806. In FIG. 8A the accessory 100 is shown positioned above the build unit 200, as indicated by arrows 808.

In one example the accessory 100 may be installed in the build unit 200, as shown in FIG. 8B, by removing the build unit filling cap 802. In the example shown in FIG. 8B, the accessory base portion 114 may fit in place of the build unit filling cap 802, and in one example may, for example, provide the connection between the build unit support platform 206 and the accessory base portion 114. In one example, the accessory base portion 114 may be screwed into a recess into which the build unit filling cap 802 fits. As illustrated in FIG. 8B, when the accessory 100 is installed in the build unit 200, the accessory filling channel cooperates 806 with the build unit filling channel 804. This enables the build unit powder supply (not shown) to be refilled by removing the accessory filling cap 802 and providing build material to the accessory filling channel 806. This enables the build unit build material store to be refilled with build material whilst the accessory is installed in the build unit.

In a yet further example, the accessory side walls 106 may be provided with heating elements, such as heat blankets, to enable the temperature of the contents of the accessory build chamber 118 to be controlled. In this example, an electrical connection may be made between the accessory 100 and the build unit 200 upon installation of the accessory 100 into the build unit 200. The 3D printer controller 406 may, for example, control the temperature of the heating elements.

It will be appreciated that example described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine readable storage storing such a program. Still further, some examples may be conveyed electronically via any medium such as a communication signal carried over a wired or wireless connection.

All of the features disclosed in this specification (including any accompanying claims, abstract and drawings), and/or all of the processes of any method or process so disclosed, may be combined in any combination, except combinations where at least some of such features and/or processes are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. An accessory for a three-dimensional (3D) printer comprising:
an upper structure to connect to a 3D printer build unit, the build unit defining a build chamber and having a movable support platform, the upper structure defining a build chamber smaller than the build chamber of the build unit, the upper structure being connectable to the build unit such that the accessory build chamber becomes the usable build chamber of the build unit; and
an accessory support platform movable within the accessory build chamber, the accessory support platform having a base portion extending below the accessory build chamber to connect to the build unit support platform, such that movement of the build unit support platform causes corresponding movement of the accessory support platform.

2. The accessory of claim 1, wherein the accessory support platform comprises an accessory filling channel to cooperate with a build unit filling channel to enable a build unit build material store to be refilled whilst the accessory is installed.

3. The accessory of claim 1, wherein the base portion is to fit into a build unit refill cap recess in the build unit support platform.

4. The accessory of claim 1, wherein the base portion is connectable to the build unit support platform by at least one of: magnetic coupling elements; and mechanical coupling elements.

5. The accessory of claim 1, wherein the upper structure comprises protrusions to fit into correspond accessory receiving recesses of a 3D printer build unit such that when installed the upper structure remains static and wherein the upper surface of the accessory is flush with the upper surface of the build unit.

6. A method of operating a three-dimensional printer to generate an object in a build unit, comprising:
determining the presence of an accessory installed in the build unit, the accessory replacing the build chamber of the built unit with a smaller build chamber; and
operating the printer with the smaller build chamber by controlling to a support platform of the build unit to move the support platform of the accessory.

7. The method of claim 6, further comprising:
adjusting the maximum and minimum height of the build unit support platform to prevent the build unit support platform from interfering with the accessory.

8. The method of claim 5, further comprising:
obtaining a three-dimensional print job defining an object to be generated;
determining if the print job can be printed in the smaller build chamber, and if so executing the print job to generate the object in the smaller build chamber.

9. The method of claim 8, further comprising:
determining whether the print job is to be repositioned such that it will be appropriate generated within the smaller build chamber, and if so repositioning the print job.

10. The method of claim 6, further comprising determining the characteristics of an installed accessory and operating the printer in accordance with the determined characteristics.

11. A three-dimensional printer to generate objects in a build unit, comprising:
a build material distribution module to form layers of build material on a support platform;
a solidification module to selectively solidify formed layers of build material in accordance with a print job defining an object to be generated;
a controller to:
determine the presence of a build unit accessory installed in the build unit, the accessory replacing the build chamber of the build unit;
control the printer to perform the print job in the accessory build chamber.

12. The three-dimensional printer of claim 11, wherein the build unit comprises a sensor to detect the presence of an accessory installed therein.

13. The three-dimensional printer of claim 11, wherein the accessory comprises a support platform that is coupled, when installed, to the build unit support platform, and wherein the 3D printer controller controls the height of the accessory support platform by controlling the height of the build unit support platform.

14. The three-dimensional printer of claim 11, wherein the build unit further comprises:
a build material store below the build unit support platform;
a build unit refill channel to allow refilling of the build material store;
and where the accessory further comprises:
an accessory refill channel that cooperates, when installed, with the build unit refill channel to allow the build material store to be refilled whilst the accessory is installed.

15. The three-dimensional printer of claim 15, wherein the accessory support platform further comprises a removable refill cap to provide access to the accessory refill channel.
